(19) United States
(12) Patent Application Publication
(10) Pub. No.: US 2002/0082076 A1
(43) Pub. Date: Jun. 27, 2002

(54) Systems and methods wherein multiple accounts are associated with a player

(76) Inventors: Susan E. Roser, Aurora, CO (US); Robert E. Boggs III, Orlando, FL (US)

Correspondence Address: BUCKLEY, MASCHOFF, TALWALKAR, & ALLISON, 5 ELM STREET, NEW CANAAN, CT, 06840, US

(21) Appl. No.: 09/748,709

(22) Filed: Dec. 27, 2000

(51) Int. Cl. G06F 17/00

(52) U.S. Cl. 463/25

(57) ABSTRACT

Systems and methods are provided wherein multiple accounts are associated with a player. According to one embodiment, a first account and a second account are associated with the player. The first account and the second account may comprise, for example, a player-funded account, a player-winnings account, a free-play account, an escrow account, a tax-withholding account, and/or a payout account. At least one of the first account and the second account may then be updated (e.g., based on game play by the player). An account may be updated, for example, as the player plays a game of skill using a remote player device to communicate with a game controller via a communication network.

### FIELD

The present invention relates to game systems. In particular, the present invention relates to systems and methods wherein multiple accounts are associated with a player.

### BACKGROUND

Many players enjoy playing games provided by game providers. For example, many players enjoy playing games of chance (e.g., a blackjack game) and games of skill (e.g., a trivia game) provided by online game providers.

It is known that a game provider, and in particular a game provider that provides games of chance, can arrange for a player to provide a payment in exchange for game play. For example, a player may use his or her credit card account to provide a payment to an online “casino.” It is also known that such a game provider can arrange for a player to receive a payment based on his or her game play (e.g., when the player wins a game of blackjack).

In general, such an online game provider establishes a “player account” for each player. The player account is increased, for example, when the player provides a payment (e.g., via a credit card account) or when the player wins a game. The player account is decreased, for example, when the player loses a game or when a payment is provided to the player (e.g., after the player “cashes out” some or all of the funds in the player account).

There are a number of disadvantages, however, with the use of such a player account. Consider, for example, a player who uses a credit card account to “deposit” fifty dollars into his or her player account. The player then wins an additional ten dollars during game play (i.e., sixty dollars are now in the player account) and asks to “cash out” his or her player account.

If the game provider cashes out the player by mailing a sixty dollar check to the player, several problems can arise. For example, the player may later dispute the initial fifty dollar charge to the credit card account. In this case, the game provider (who has already paid that fifty dollars to the player) may unfairly lose money. Moreover, providing a monetary payment to a player after receiving funds via a credit card account may be prohibited (e.g., prohibited by a credit card association or a governmental authority).

If the game provider instead cashes out the player by applying the sixty dollars to the player's credit card account, the player may not be satisfied. That is, the player may prefer to have his or her winnings paid by check (particularly if he or she has won a large prize amount). In addition, a player may be more psychologically satisfied when he or she receives an actual payment from the game provider (e.g., by receiving a check in the mail) as compared to merely seeing a credit applied to his or her credit card statement. Further, applying funds to the player's credit card account in this way may also be prohibited (e.g., prohibited by a credit card association or a governmental authority).

Another disadvantage arises when a game provider attempts to provide complimentary game play to a player. For example, a game provider may want to award ten dollars of free game play to a player who has been a good customer. If the game provider merely increases the player account by ten dollars, however, the player will be able to convert what was supposed to be complimentary game play into a monetary payment (e.g., by cashing out his or her player account). Such a result may be unfair to the game provider. That is, providing ten dollars of free game play would generally cost the game provider significantly less than ten dollars.

Still another disadvantage arises if a player can potentially win a large prize amount (e.g., if the player can potentially win a million dollar prize). A game provider may want to more carefully review a game result associated with a large prize amount as compared to game results associated with smaller prize amount (e.g., ten dollar prize amounts). For example, the game provider may want to make sure that the player did not unfairly achieve a game result. Moreover, the game provider may want to, be required to, take additional steps with respect to large prize amount (e.g., by calculating and withholding any applicable tax amounts).

If the game provider delays payment of all prize amounts (e.g., by delaying payment of small and large prize amounts for thirty days), a player may perceive that the game provider is being unfair, particularly with respect to the small prize amounts. Moreover, a player may be more psychologically satisfied when he or she quickly receives a payment from the game provider (e.g., by receiving a check within a few days) as compared to receiving a payment after an extended delay.

### SUMMARY

To alleviate problems inherent in the prior art, the present invention introduces systems and methods wherein multiple accounts are associated with a player.

According to one embodiment, a player-funded account associated with a player is established, the player-funded account representing an amount provided by the player in exchange for game play. A player-winnings account associated with the player is also established, the player-winnings account representing an amount to be provided to the player based on game play. At least one of the player-funded account and the player-winnings account are then updated based on game play by the player.

According to another embodiment, a player-funded account associated with a player is established. A free-play account associated with the player is also established, the free-play account representing complimentary game play to be provided to the player. At least one of the player-funded account and the free-play account are then updated based on game play by the player.

According to another embodiment, a player-funded account associated with a player is established. An escrow account associated with the player is also established, the escrow account representing an amount to be provided to the player pending certification of a game result. At least one of the player-funded account and the escrow account are then updated based on game play by the player.

According to still another embodiment, a player-funded account, a player-winnings account, and a free-play account associated with a player are established, and at least one of the accounts are then updated based on game play by the player.

According to yet another embodiment, a player-funded account, a player-winnings account, a free-play account, and an escrow account associated with a player are established, and at least one of the accounts are then updated based on game play by the player.

According to another embodiment, a player-winnings account and a free-play account associated with a player are established, and at least one of the accounts are then updated based on game play by the player.

According to another embodiment, a player-winnings account and an escrow account associated with a player are established, and at least one of the accounts are then updated based on game play by the player.

According to another embodiment, a first account and a second account associated with a player are established. The first account or the second account may comprise, for example, a player-funded account, a player-winnings account, a free-play account, an escrow account, a tax-withholding account, and/or a payout account. At least one of the first account and the second account may then be updated (e.g., based on game play by the player).

According to still another embodiment, it is arranged for a first account associated with a player and a second account associated with the player to be established.

According to still another embodiment, it is arranged for value to be transferred between a first account associated with a player and a second account associated with the player. For example, value may be transferred at the player's request and/or when a predetermined condition is satisfied (e.g., when a game result has been certified).

According to yet another embodiment, information related to a first account associated with a player is displayed along with information related to a second account associated with the player.

One embodiment of the present invention comprises: means for establishing a first account associated with a player; means for establishing a second account associated with the player; and means for updating at least one of the first account and the second account based on game play by the player.

Another embodiment comprises: means for establishing a player-funded account associated with a player, the player-funded account representing an amount provided by the player in exchange for game play; means for establishing a player-winnings account associated with the player, the player-winnings account representing an amount to be provided to the player based on game play; means for establishing a free-play account associated with the player, the free-play account representing complimentary game play to be provided to the player; means for establishing an escrow account associated with the player, the escrow account representing an amount to be provided to the player pending certification of a game result; and means for updating at least one of the player-funder account, the player-winnings account, the free-play account, and the escrow account based on game play by the player.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of a game system according to an embodiment of the present invention.

FIG. 2A is a flow chart of a method for facilitating game play according to an embodiment of the present invention.

FIG. 2B illustrates two game displays according to an embodiment of the present invention.

FIG. 3 is a block diagram of a player device according to an embodiment of the present invention.

FIG. 4 is a block diagram of a game controller according to an embodiment of the present invention.

FIG. 5 is a tabular representation of a portion of a player database according to an embodiment of the present invention.

FIG. 6 is a tabular representation of a record in a player-funded account database according to an embodiment of the present invention.

FIG. 7 is a tabular representation of a record in a player-winnings account database according to an embodiment of the present invention.

FIG. 8 is a tabular representation of a record in a free-play account database according to an embodiment of the present invention.

FIG. 9 is a tabular representation of a record in an escrow account database according to an embodiment of the present invention.

FIG. 10 is a tabular representation of a portion of an account rules database according to an embodiment of the present invention.

FIG. 11 is a flow chart of a method according to an embodiment of the present invention.

FIG. 12 is a flow chart of a method according to another embodiment of the present invention.

FIGS. 13A and 13B are account flow diagrams according to an embodiment of the present invention.

FIGS. 14A through 14C illustrate player devices displaying information according to some embodiments of the present invention.

### DETAILED DESCRIPTION

Embodiments of the present invention are directed to systems and methods wherein multiple “accounts” are associated with a player. As used herein, the term “account” refers to any information representing a right or obligation associated with a player. An account may represent, for example, a payment that has been provided by, or is to be provided to, a player. An account may also represent game play that is to be provided to a player (e.g., a number of games or a duration of game play). An account may also represent some other benefit, such as a score or an alternate currency amount (e.g., a gift certificate amount), that is associated with a player.

Game System Overview

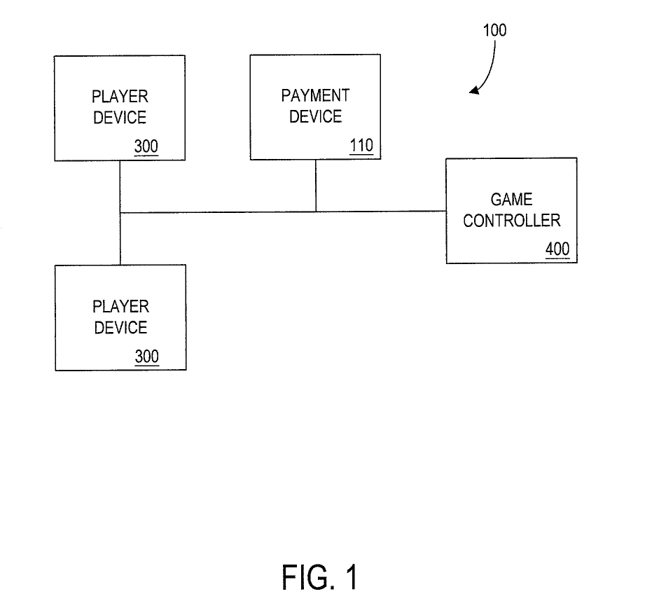

Turning now in detail to the drawings, FIG. 1 is a block diagram of a game system 100 according to one embodiment of the present invention. The game system 100 includes a game controller 400 in communication with a number of player devices 300. As used herein, devices (such as the player devices 300 and the game controller 400) may communicate, for example, via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Moreover, as used herein, communications include those enabled by wired or wireless technology. Note that although a single game controller 400 is shown in FIG. 1, any number of game controllers 400 may be included in the game system 100. Similarly, any number of the other devices described herein may be included in the game system 100 according to embodiments of the present invention.

In one embodiment of the present invention, a player device 300 communicates with a remote, Web-based game controller 400 (e.g., a server) via the Internet. Although some embodiments of the present invention are described with respect to information exchanged using a Web site, according to other embodiments information can instead be exchanged, for example, via: a telephone, an Interactive Voice Response Unit (IVRU), electronic mail, a WEBTV® interface, a cable network interface, and/or a wireless communication system.

The player device 300 and the game controller 400 may be any devices capable of performing the various functions described herein. The player device 300 may be, for example: a Personal Computer (PC), a portable computing device such as a Personal Digital Assistant (PDA), a wired or wireless telephone, a one-way or two-way pager, a kiosk (e.g., a game kiosk located at an airport terminal), an interactive television device, a game terminal (e.g., a SONY PLAY STATION® video game terminal), or any other appropriate storage and/or communication device.

Note that the devices shown in FIG. 1 need not be in constant communication. For example, the player device 300 may only communicate with the game controller 400 via the Internet when appropriate (e.g., when attached to a “docking” station or “cradle” coupled to the player's PC). The player device 300 may also communicate with the game controller 400 via an infrared device when near a game kiosk. Note also that a player device 300 and the game controller 400 may be incorporated in a single device (e.g., a game kiosk may act as both a player device 300 and the game controller 400).

According to an embodiment of the present invention, a player uses a player device 300 to communicate with the game controller 400. For example, a player may use his or her PC to access a Web site associated with the game controller 400 in order to play a game. In this case, the game controller 400 may establish and/or update multiple accounts associated with the player.

The player may then use his or her player device 300 to play a game. For example, a player may use a keyboard or mouse coupled to his or her PC to play a game of skill (e.g., a computer-based golf game associated with a physics simulation).

According to one embodiment, the game controller 400 also arranges for the player to provide a payment in exchange for playing a game and/or arranges for the player to receive a payment in accordance with multiple accounts that are associated with the player. For example, the game controller 400 may arrange for $1,000 to be added to one of the player's accounts if he or she correctly answers twenty trivia questions. According to such an embodiment, a payment device 110 may be used to arrange for the player to provide and/or receive payments. For example, the game controller 400 may arrange for a player to purchase one or more game plays via the payment device 110 (e.g., via a credit card account, a debit card account, a banking account, or an electronic payment protocol). The payment device 110 may also comprise, for example, a third party device (e.g., a credit card processing device), a check printer, and/or or an Automated Clearing House (ACH) device (e.g., when arranging to provide a “direct deposit” payment via a player's bank account).

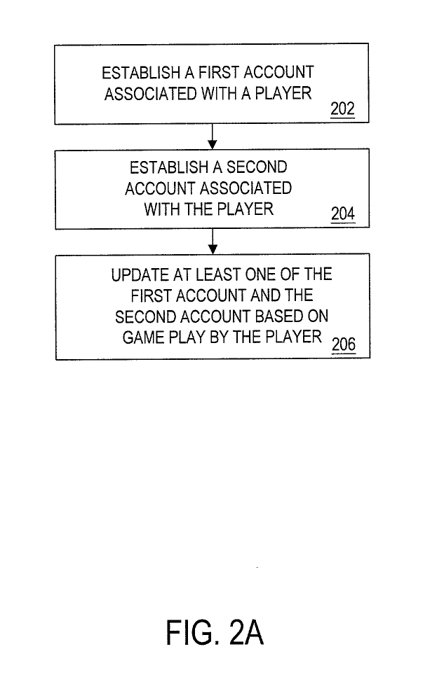

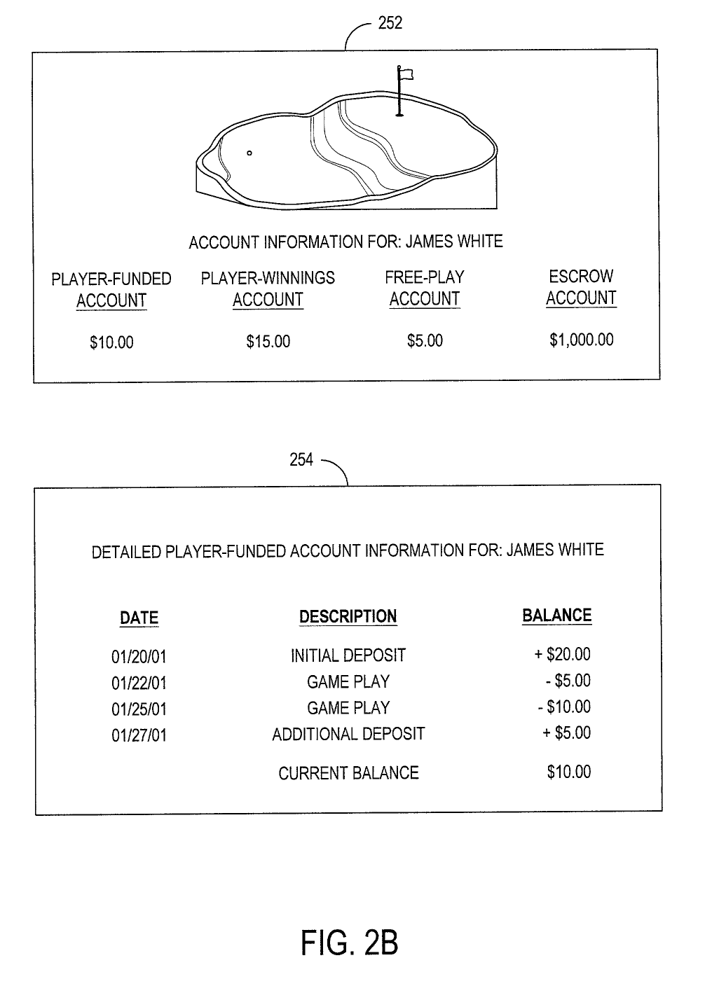

FIG. 2A is a flow chart of a method for facilitating games played via the game system 100 according to an embodiment of the present invention. The method shown in FIG. 2A may be performed, for example, by the game controller 400 and/or a player device 300. At 202, a first account associated with a player is established. At 204, a second account associated with the player is established. The first account and the second account may comprise, for example, a player-funded account, a player-winnings account, a free-play account, and/or an escrow account. At least one of the first account and the second account are then updated based on game play by the player at 206.

By way of example, the game controller 400 may establish a player-funded account (e.g., a first account) associated with a player when he or she registers with a game provider. The player-funded account may represent, for example, an amount provided by the player in exchange for game play. The game controller 400 may also establish a player-winnings account (e.g., a second account) associated with the player. The player-winnings account may represent, for example, an amount to be provided to the player based on his or her game play. As will be explained, the game controller 400 may then update the player-funded account and the player-winnings account based on his or her game play.

According to one embodiment, the game controller 400 arranges via a payment identifier to receive payment of a “funding amount” from the player. The payment identifier may be associated with, for example, the player's credit card account, debit card account, or bank account. According to another embodiment, the payment identifier may be associated with any digital payment protocol. When a payment is received or authorized (e.g., by a credit card device), the game controller 400 increases the player-funded account by the funding amount.

The game controller 400 may also provide game play to the player (e.g., via a player device 300), in which case the player-funded account can be decreased as appropriate based on the game play (e.g., the player-funded account may be decreased by $1.00 each time the player plays a game).

The game controller 400 may also arrange via the payment identifier to provide payment of a refund amount to the player (e.g., when the player requests to cash out his or her player-funded account). In this case, the game controller 400 decreases the player-funded account by the refund amount.

According to an embodiment of the present invention, the game controller 400 can also determine a “game result” associated with the player (e.g., a game score) and increase the player-winnings account based on the game result (e.g., a player may win $5.00 if he or she achieves a score of at least 5,000 points in a particular game).

The game controller 400 may provide payment of an amount based on the player-winnings account to the player without using the payment identifier. For example, the game controller 400 may mail a check to the player based on the amount in the player-winnings account. Because the game controller 400 has associated both a player-funded account (representing amounts that will be refunded via the payment identifier) and a player-winnings account (representing amounts that will be paid to the player without using the payment identifier) with the player, a game provider may avoid violating credit card association regulations when a player “cashes out” his or her accounts.

The player-winnings account may also be decreased by the game controller 400 in exchange for game play provided to the player. Note that the game controller 400 may decrease either the player-funded account or the player-winnings account in exchange for game play. The game controller 400 may determine which account to decrease, for example, based on information received from the player (e.g., information received when the player requests game play or player preference information received when the player registered with the game controller 400).

According to another embodiment, the game controller 400 determines which account to decrease based on the funds available in each account. For example, the game controller 400 may first decrease the player-funded account, to the extent that sufficient funds are available, and then decrease the player-winnings account, to the extent that such funds were not available in the player-funded account.

In addition to the player-funded account and the player-winnings account, the game provider may establish a free-play account associated with the player. The free-play account may represent, for example, complimentary game play to be provided to the player. For example, the game controller 400 may monitor game play by the player and increase the free-play account based on a predetermined rule (e.g., the free-play account may be increased by $5.00 after the player has played fifty games). The game controller 400 may also decrease the free-play account as the complimentary game play is used by the player. According to one embodiment, a player may indicate whether or not the free-play account is to be used to “pay” for a particular game. According to another embodiment, the game controller 400 determines if the free-play account is to be used instead of the player-funded account and/or the player-winnings account.

The game controller 400 may also establish an escrow account associated with the player. The escrow account may represent, for example, an amount to be provided to the player pending certification of a game result. For example, the game controller 400 may determine a prize amount associated with a player's game result. If the prize amount is not greater than a threshold amount (e.g., $10,000), the game controller 400 may increase the player-winnings account. If the prize amount is greater than the threshold amount, the game controller 400 may instead increase the escrow account.

The game provider can then “certify” a game result before providing payment to the player. For example, the game provider may evaluate game information to determine if the player unfairly achieved the game result. The game provider may also, for example, verify the identity of the player (e.g., via his or her Social Security number) or other information for tax purposes. After the game result is certified and payment is provided to the player (or, according to another embodiment, after funds are transferred from the escrow account to the player-winnings account), the game controller 400 decreases the escrow account by the appropriate amount.

In this way, the game provider can quickly provide payments of small prize amounts to the player (e.g., represented by the player-winnings account) while still delaying payment of larger prize amounts as appropriate (e.g., to make sure that the player has not unfairly achieved a game result).

According to another embodiment, several different escrow accounts, each associated with a different threshold, are established by the game controller 400. For example: prize amounts of not more than $500 may be paid immediately; prize amounts of more than $500 but not more than $5,000 may be paid after seven days; and prize amounts of more than $5,000 may be paid after thirty days.

Other types of accounts that may be associated with a player include, for example, a tax-withholding account (e.g., representing an amount that has been won by a player but not paid to the player for tax purposes) and a payout account (e.g., representing an amount being processed for payment to a player).

Account Information Display

Consider now FIG. 2B, which illustrates a first game display 252 according to an embodiment of the present invention. The first game display 252 may be provided, for example, at a player device 300 based on information received from the game controller 400. According to another embodiment, some or all of the account information described with respect to FIG. 2B is displayed to an operator associated with the game controller 400 or a game provider. For example, the account information may be displayed when a telephone call center operator is speaking with a player.

The first game display 252 indicates information associated with a player-funded account, a player-winnings account, a free-play account, and an escrow account. According to another embodiment, account balances from a number of different accounts may be combined when displayed to the player. For example, the amounts in the player-funded account and player-winnings account may be combined when displayed to the player.

As shown in the second game display 254, more detailed information associated with one or more of the accounts can also be indicated (e.g., when the player select one of the accounts via the first game display 252). The more detailed information may include, for example, transaction details associated with that particular account (e.g., a date and description associated with each transaction).

Player Device

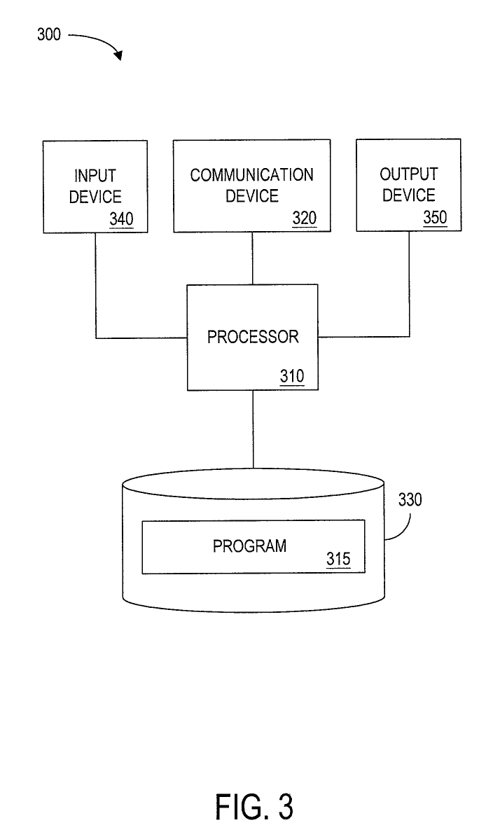

FIG. 3 illustrates a player device 300 that is descriptive of the device shown in FIG. 1 according to an embodiment of the present invention. The player device 300 comprises a processor 310, such as one or more INTEL® Pentium® processors, coupled to a communication device 320 configured to communicate via a communication network (not shown in FIG. 3). The communication device 320 may be used to communicate, for example, with the game controller 400 and/or the payment device 110.

The processor 310 is also in communication with an input device 340. The input device 340 may comprise, for example, a keyboard, a mouse or other pointing device, a microphone, a knob or a switch (including an electronic representation of a knob or a switch), an infrared port, a docking station, and/or a touch screen. Such an input device 340 may be used, for example, by a player to play a game (e.g., by manipulating a pointer associated with a computer-based golf game).

The processor 310 is also in communication with an output device 350. The output device 340 may comprise, for example, a display (e.g., a computer monitor), a speaker, and/or a printer. The output device 350 may be used, for example, to provide game and account information to a player.

The processor 310 is also in communication with a storage device 330. The storage device 330 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 330 stores a program 315 for controlling the processor 310. The processor 310 performs instructions of the program 315, and thereby operates in accordance with the present invention. For example, the processor 310 may arrange for a player to play a game and/or for account information to be displayed to the player.

As used herein, information may be “received” by or “transmitted” to, for example: (i) the player device 300 from the game controller 400; or (ii) a software application or module within the player device 300 from another software application, module, or any other source.

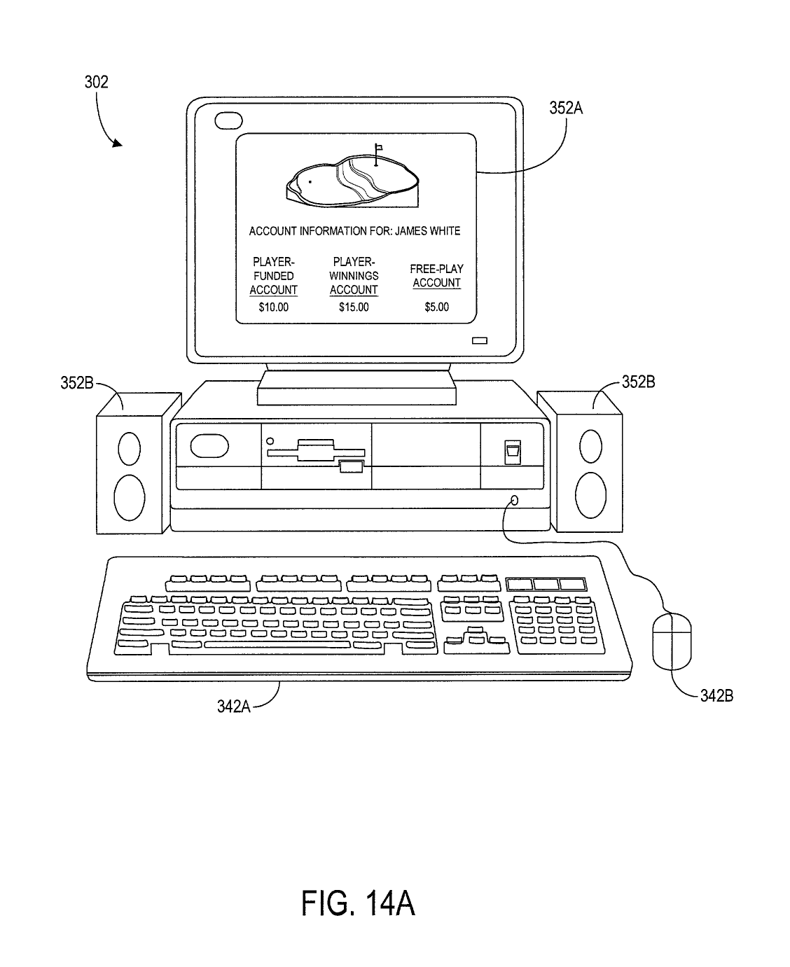

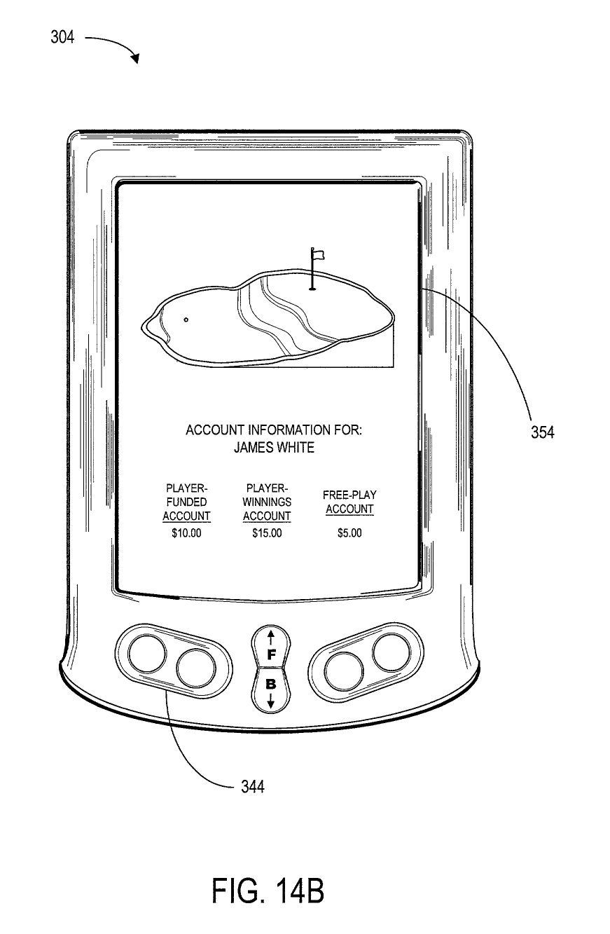

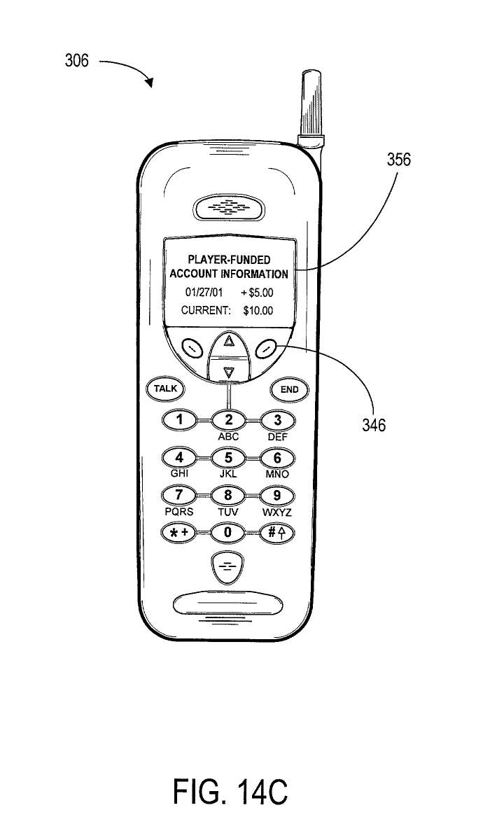

FIG. 14A illustrates a PC 302 displaying account information according to an embodiment of the present invention. The PC 302 includes a keyboard 342A and a mouse 342B which can be used by a player to play a game. The PC 302 also includes a computer display 352A and speakers 352B which can be used to, for example, provide account information to a player.

FIG. 14B illustrates a PDA 304 displaying account information according to another embodiment of the present invention. The PDA 304 includes an input device 344 and an output device 354 (e.g., a display screen) that may be used by a player to play a game. Similarly, FIG. 14C illustrates a wireless telephone 306 including an input device 346 and an output device 356 displaying account information.

Game Controller

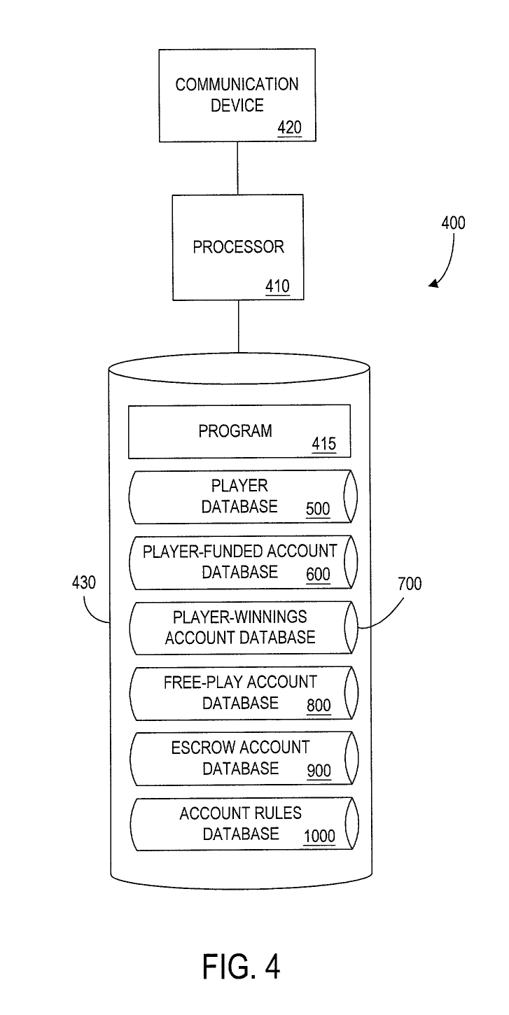

FIG. 4 illustrates a game controller 400 that is descriptive of the device shown in FIG. 1 according to an embodiment of the present invention. The game controller 400 comprises a processor 410, such as one or more INTEL® Pentium® processors, coupled to a communication device 420 configured to communicate via a communication network (not shown in FIG. 4). The communication device 420 may be used to communicate, for example, with one or more player devices 300 and/or the payment device 110.

The processor 410 is also in communication with a storage device 430. The storage device 430 may comprise any appropriate information storage device, including combinations of magnetic storage devices (e.g., magnetic tape and hard disk drives), optical storage devices, and/or semiconductor memory devices such as RAM devices and ROM devices.

The storage device 430 stores a program 415 for controlling the processor 410. The processor 410 performs instructions of the program 415, and thereby operates in accordance with the present invention. For example, the processor 410 may establish a first account and a second account associated with a player. The processor 410 may then update at least one of the accounts (e.g., based on game play by the player).

According to another embodiment, the processor 410 establishes a player-funded account associated with a player (representing an amount provided by the player in exchange for game play). The processor 410 also establishes a player-winnings account (representing an amount to be provided to the player based on game play), a free-play account (representing complimentary game play to be provided to the player), and an escrow account (representing an amount to be provided to the player pending certification of a game result) associated with the player and updates at least one of the accounts (e.g., based on game play by the player).

The program 415 may be stored in a compressed, uncompiled and/or encrypted format. The program 415 may furthermore include other program elements, such as an operating system, a database management system, and/or device drivers used by the processor 410 to interface with peripheral devices.

As used herein, information may be “received” by or “transmitted” to, for example: (i) the game controller 400 from the player device 300; or (ii) a software application or module within the game controller 400 from another software application, module, or any other source.

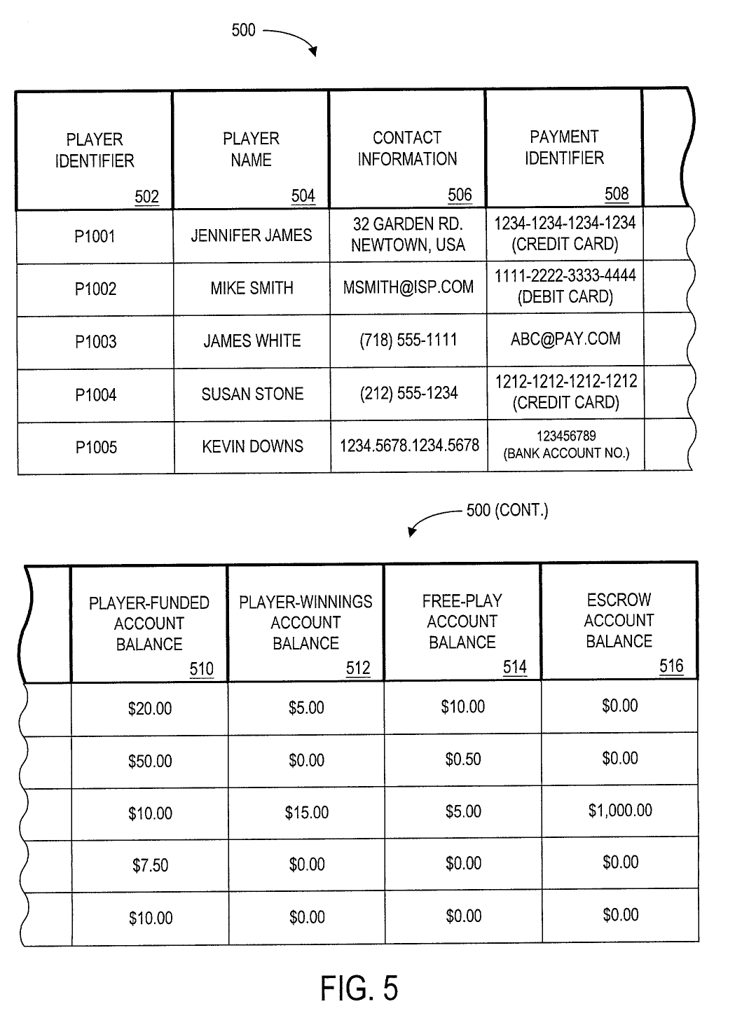

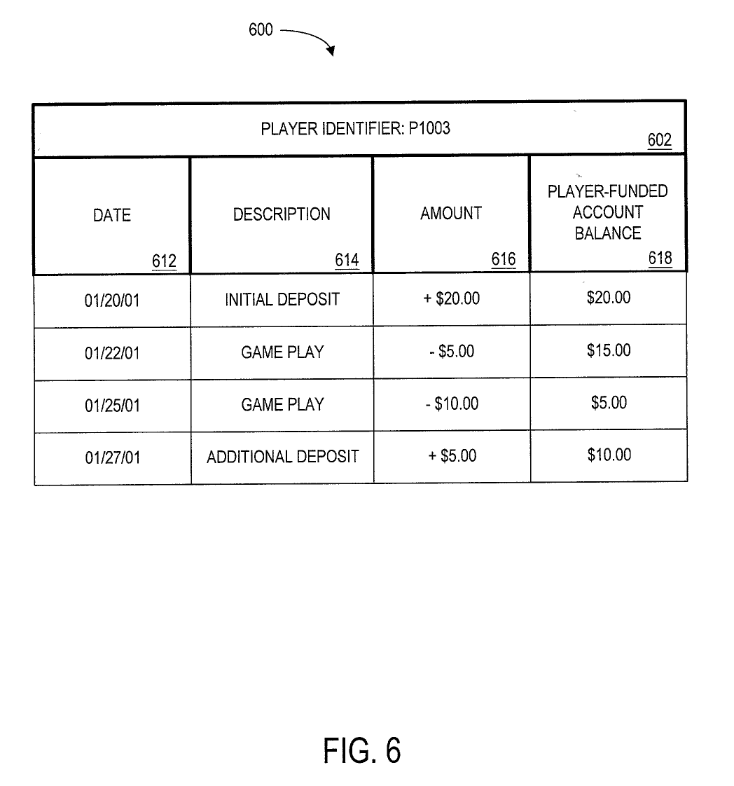

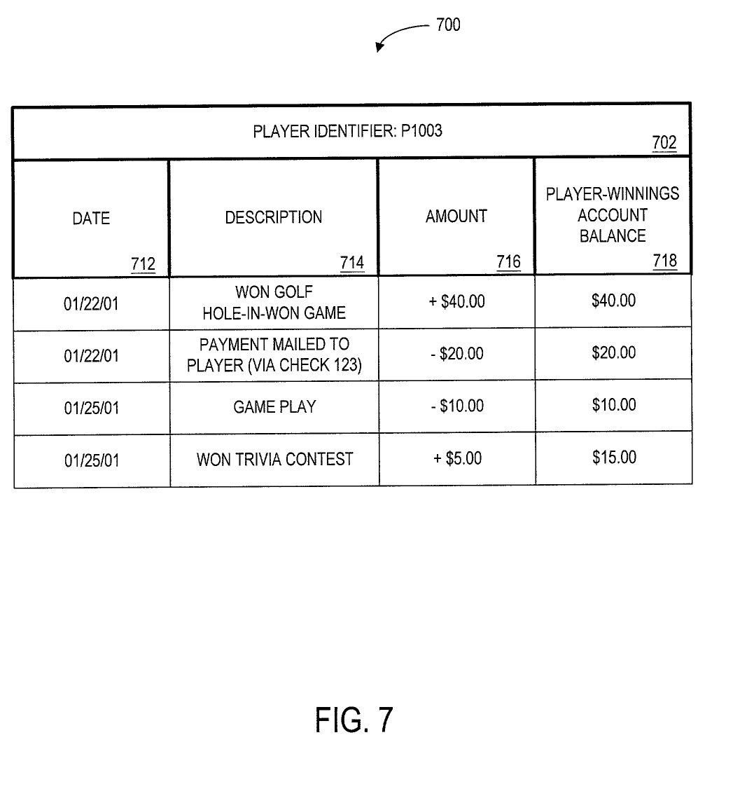

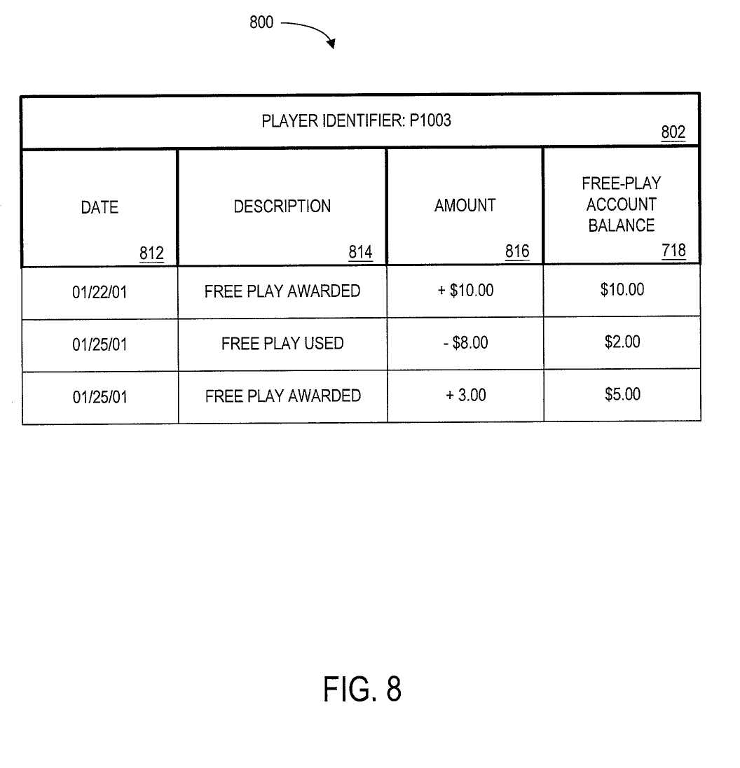

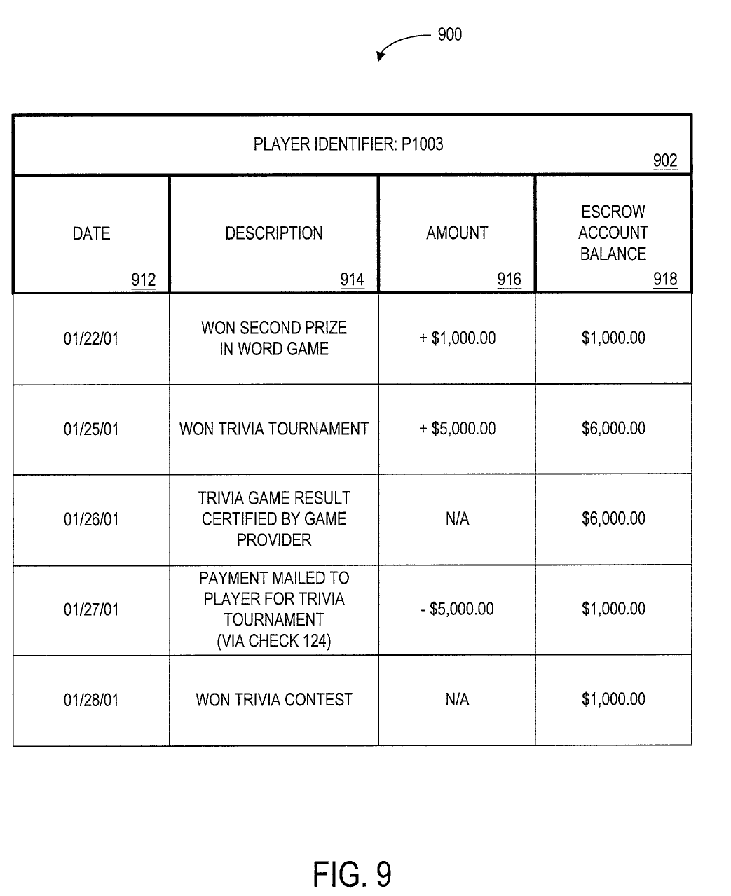

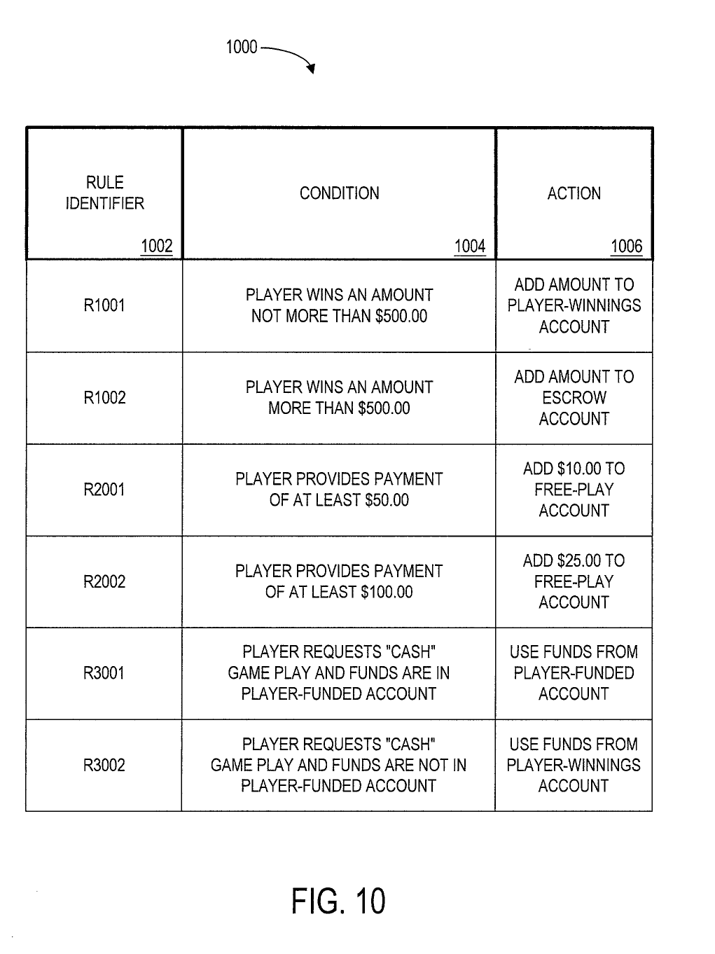

As shown in FIG. 4, the storage device 430 also stores a player database 500 (described with respect to FIG. 5), a player-funded account database 600 (described with respect to FIG. 6), a player-winnings account database 700 (described with respect to FIG. 7), a free-play account database 800 (described with respect to FIG. 8), an escrow account database 900 (described with respect to FIG. 9), and an account rules database 1000 (described with respect to FIG. 10). Examples of databases that may be used in connection with the game system 100 will now be described in detail with respect to FIGS. 5 through 10. The illustrations and accompanying descriptions of the databases presented herein are exemplary, and any number of other database arrangements could be employed besides those suggested by the figures.

Player Database

Referring to FIG. 5, a table represents the player database 500 that may be stored at the game controller 400 according to an embodiment of the present invention. The table includes entries identifying players who may play games via the game system 100. The table also defines fields 502, 504, 506, 508, 510, 512, 514, 516 for each of the entries. The fields specify: a player identifier 502, a name 504, contact information 506, a payment identifier 508, a player-funded account balance 510, a player-winnings account balance 512, a free-play account balance 514, and an escrow account balance 516. The information in the player database 500 may be created and updated, for example, based on information received from player when he or she registers with the game controller 400. The information in the player database 500 may also be based on, for example, information generated as the player plays games via the game system 100.

The player identifier 502 may be, for example, an alphanumeric code associated with a player who has registered to use the game system 100. The player identifier 502 may be generated by, for example, the game controller 400 or the player (e.g., when the player provides a user name and password). The player database 500 also stores the name 504 and contact information 506 (e.g., a postal address, an electronic mail address, an IP address, or a telephone number) associated with each player.

The payment identifier 508 may comprise, for example, a credit card, debit card or bank account number (e.g., a checking account number) or digital payment protocol information. The payment identifier 508 may be used, for example, by the game controller 400 to arrange for the player to provide or receive a payment.

The player-funded account balance 510 may represent an amount that has been provided by the player (e.g. via his or her credit card account) in exchange for game play. The player-winnings account balance 512 may represent an amount to be provided to the player based on game play (e.g., a total amount that has been won by the player). The free-play account balance 514 may represent complimentary game play to be provided to the player (e.g., complimentary game play won by the player during game play or other awarded to the player). The escrow account balance 516 may represent an amount to be provided to the player pending certification of a game result. Note that these account balances do not need to represent monetary amounts. For example, some of the account balances may be expressed as an amount of game play (e.g., a player may have “twenty free games” or “ten minutes of free game play” in his or her free-play account).

The account balances 510, 512, 514, 516 will now be explained in more detail with respect to FIGS. 6 through 9.

Player-Funded Account Database

Referring to FIG. 6, a table represents a record in the player-funded account database 600 that may be stored at the game controller 400 according to an embodiment of the present invention. The database includes records associated with players who may play games via the game system 100. As shown in FIG. 6, each record indicates a player identifier 602 associated with a player. The player identifier 602 may be, for example, an alphanumeric code based on, or associated with, the player identifier 502 stored in the player database 500.

The table also defines fields 612, 614, 616, 618 for each record. The fields specify: a date 612, a description 614, an amount 616, and a player-funded account balance 618. The information in the player-funded account database 600 may be created, for example, when a player registers with the game controller 400 to play games via the game system 100. The information in the player-funded account database 600 may also be updated by the game controller 400 when a player provides payment and/or receives game play.

The date 612 indicates a date of a player-funded account transaction, the description 614 provides details about the transaction, and the amount 616 represents an amount associated with the transaction. The player-funded account balance 618 indicates a current amount that has been provided by the player in exchange for game play (e.g., an amount that has been paid by the player and not yet used).

As shown in FIG. 6, a player may initially deposit an amount in the player-funded account, such as when he or she registers with the game controller 400. For example, a player may deposit an amount into the account using the payment identifier 508 stored in the player database 500 (e.g., via his or her credit card account).

Other types of transactions that may be recorded in the player-funded account database 600 include, for example, the use of funds in the account in exchange for game play and additional deposits into the account. According to one embodiment, a player can also request a refund of some or all of the funds in the player-funded account. In this case, the game controller 400 may arrange for the requested refund to be provided to the player using the payment identifier 508 stored in the player database 500 (e.g., via his or her credit card account).

Player-Winnings Account Database

By Referring to FIG. 7, a table represents a record in the player-winnings account database 700 that may be stored at the game controller 400 according to an embodiment of the present invention. The database includes records associated with players who may play games via the game system 100. As shown in FIG. 7, each record indicates a player identifier 702 associated with a player. The player identifier 702 may be, for example, an alphanumeric code based on, or associated with, the player identifier 502 stored in the player database 500.

The table also defines fields 712, 714, 716, 718 for each record. The fields specify: a date 712, a description 714, an amount 716, and a player-winnings account balance 718. The information in the player-winnings account database 700 may be created and updated, for example, based on information generated as the player plays games via the game system 100.

The date 712 indicates a date of a player-winnings account transaction, the description 714 provides details about the transaction, and the amount 716 represents an amount associated with the transaction. The player-winnings account balance 718 indicates a current amount to be provided to the player based on game play (e.g., an amount that has been won by, but not yet paid to, the player).

For example, as shown in FIG. 7, the amount in the player-winnings account may be increased when a player wins a game (e.g., by scoring at least a predetermined number or points or by winning a tournament). The amount in the player-winnings account may be decreased, for example, when some or all of the amount is paid to the player (e.g., by mailing a check to the player or via the player's credit card account). The amount in the player-winnings account may also be decreased if the player uses some or all of the amount in exchange for further game play.

Free-Play Account Database

Referring to FIG. 8, a table represents a record in the free-play account database 800 that may be stored at the game controller 400 according to an embodiment of the present invention. The database includes records associated with players who may play games via the game system 100. As shown in FIG. 8, each record indicates a player identifier 802 associated with a player. The player identifier 802 may be, for example, an alphanumeric code based on, or associated with, the player identifier 502 stored in the player database 500.

The table also defines fields 812, 814, 816, 818 for each record. The fields specify: a date 812, a description 814, an amount 816, and a free-play account balance 818. The information in the free-play account database 800 may be created and updated, for example, based on information generated as the player plays games via the game system 100.

The date 812 indicates a date of a free-play account transaction, the description 814 provides details about the transaction, and the amount 816 represents an amount associated with the transaction. The free-play account balance 818 indicates complimentary game play to be provided to the player (e.g., game play that has been awarded to, but not yet used by, the player).

The amount in the free-play account may be increased, for example, to reward a player who wins a game (e.g., by scoring a predetermined number of points or by winning a tournament). A player may also be rewarded, for example, when he or she registers with the game controller 400 and/or purchases a predetermined amount of game play. Complimentary game play may be given to players who, for example, have played a predetermined number of games, have used the gaming system 100 for a predetermined period of time (e.g., players who are loyal to a game provider), or even to those players who have not used the gaming system 100 for a predetermined period of time (e.g., to entice those players to return to a game provider).

The amount in the free-play account may be decreased, for example, when the player decides to use some or all of the amount in exchange for game play. According to one embodiment, the amount in the free account may be decreased after a predetermined period of time (e.g., complimentary game play may “expire” after seven days or at the end of the year).

Escrow Account Database

Referring to FIG. 9, a table represents a record in the escrow account database 900 that may be stored at the game controller 400 according to an embodiment of the present invention. The database includes records associated with players who may play games via the game system 100. As shown in FIG. 9, each record indicates a player identifier 902 associated with a player. The player identifier 902 may be, for example, an alphanumeric code based on, or associated with, the player identifier 502 stored in the player database 500.

The table also defines fields 912, 914, 916, 918 for each record. The fields specify: a date 912, a description 914, an amount 916, and a escrow account balance 918. The information in the escrow account database 900 may be created and updated, for example, based on information generated as the player plays games via the game system 100. The information in the escrow account database 900 may also be updated by the game controller 400, for example, when a player wins a prize (e.g., a prize amount over a predetermined threshold amount), when a game result has been certified by a game provider, and/or when it has been arranged for the player to receive payment of a prize amount.

The date 912 indicates a date of an escrow account transaction, the description 914 provides details about the transaction, and the amount 916 represents an amount associated with the transaction. The escrow account balance 918 indicates a current amount to be provided to the player pending certification of a game result (e.g., an amount that has been won by, but not yet paid to, the player).

For example, as shown in FIG. 9, the amount in the escrow account may be increased when a player wins a large prize amount (e.g., by scoring at least a predetermined number of points or by winning a tournament). The amount in the escrow account may be decreased, for example, when some or all of the amount is paid to the player (e.g., via the player's credit card account or by mailing a check to the player) after a game result is certified by a game provider. According to another embodiment, value in the escrow account is instead transferred to, for example, the player-winnings account, a tax-withholding account, and/or a payout account.

The amount in the escrow account may also be decreased if, for some reason, a game provider decides that a game result will not be certified (e.g., if the game provider determines that the player cheated during a game).

Account Rules Database

Referring to FIG. 10, a table represents the account rules database 1000 that may be stored at the game controller 400 according to an embodiment of the present invention. The table includes entries identifying rules that may be used by the game controller 400 to determine, for example, which accounts should be updated as a player uses the game system 100. The table also defines fields 1002, 1004, 1006 for each of the entries. The fields specify: a rule identifier 1002, a condition 1004, and an action 1006. The information in the account rules database 1000 may be created and updated, for example, by a game provider associated with the game controller 400.

The rule identifier 1002 may be, for example, an alphanumeric code associated with an account rule. The condition 1004 indicates one or more conditions that may be evaluated by the game controller 400. The action 1006 indicates one or more acts or steps that may be performed by the game controller 400 when an associated condition 1004 is satisfied.

For example, as illustrated by the first two entries shown in FIG. 10 (i. e., having a rule identifier 1002 of “R1001” and “R1002”), a game controller may evaluate an amount won by a player to determine if the amount is more than a predetermined threshold amount (e.g., “$500”). If the amount won by the player is not more than the predetermined threshold amount, the winnings may be placed directly into the player-winnings account. In this case, the player can immediately arrange to receive payment of the amount. According to another embodiment, such winnings may instead be directly paid to the player.

It the amount won by the player is more than the predetermined threshold amount, the winnings may instead be placed in the escrow account. This may let a game provider evaluate information associated with a game to certify or validate a game result. For example, the game provider may attempt to determine if the player has used a false identity, has unfairly collaborated with other players, or has attempt to cheat or defraud the game provider in any way (e.g., by having an automated game playing device, such as a “game-bot,” play a game). The escrow account may also let the game provider perform other steps that are required when a large prize is won by a player (e.g., by calculating and withholding any applicable tax amounts).

As another example, consider the third and fourth entries shown in FIG. 10 (i.e., having a rule identifier 1002 of “R2001” and “R2002”). These account rules identify an amount of complimentary game play to be awarded to a player when he or she purchases game play.

The last two entries shown in FIG. 10 (i e., having a rule identifier 1002 of “R3001” and “R3002”) illustrate account rules applicable when a player requests to receive game play in exchange for funds from his or her “cash” accounts (e.g., his or her player-funded account and/or player-winnings account). Consider first a player who “purchases” game play using funds from his or her free-play account. In this case, the game provider simply provides the game play to the player and decreases the free-play account by an appropriate amount. If the player instead purchases game play using funds from his or her “cash” accounts, the game controller 400 first determines if funds are available in the player-funded account. If so, those finds are used. If funds are not available in the player-funded account, then funds from the player-winnings account are used by the controller 400. Of course, funds from both the player-funded account and the player-winnings account may be used if needed.

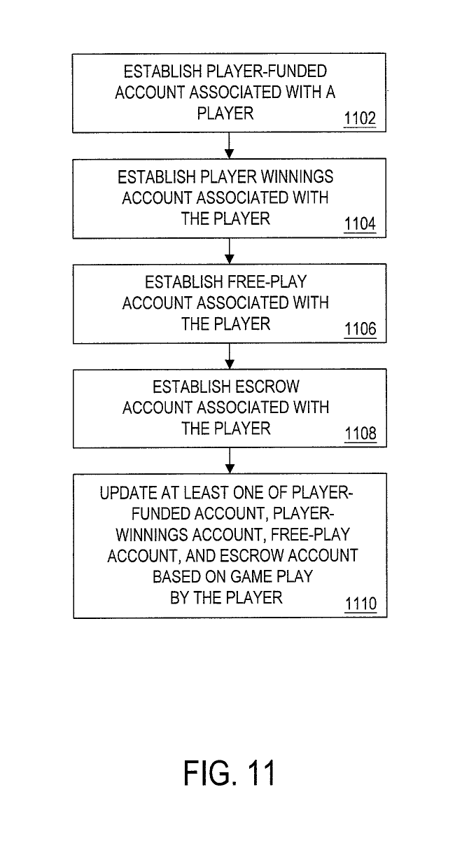

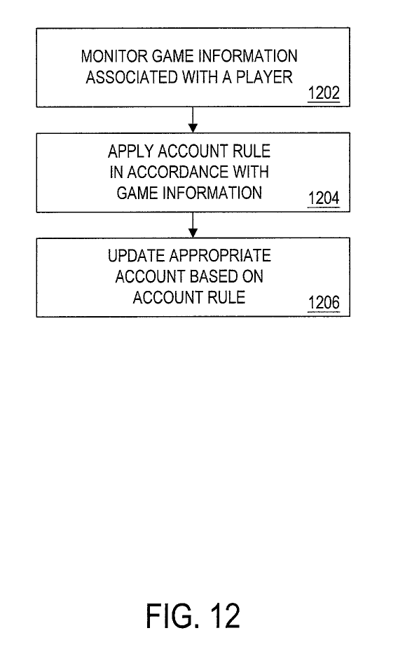

Methods that may be used in connection with the game system 100 according to some embodiments of the present invention will now be described in detail with respect to FIGS. 11 and 12.

Game System Methods

FIG. 11 is a flow chart of a method that may be performed by the game controller 400 according to an embodiment of the present invention. The flow charts in FIG. 11 and the other figures described herein do not imply a fixed order to the steps, and embodiments of the present invention can be practiced in any order that is practicable. Moreover, the methods may be performed by any of the devices described herein, including a player device 300.

At 1102, a player-funded account associated with a player is established, the player-funded account representing an amount provided by the player in exchange for game play. For example, the game controller 400 may add a record associated with the player to the player-funded account database 600 when the player registers with a game provider.

At 1104, a player-winnings account associated with the player is established, the player-winnings account representing an amount to be provided to the player based on game play. For example, the game controller 400 may add a record associated with the player to the player-winnings account database 700 when the player registers with the game provider. According to another embodiment, the player-winnings account is instead established when the player first wins a prize amount.

At 1106, a free-play account associated with the player is established, the free-play account representing complimentary game play to be provided to the player. For example, the game controller 400 may add a record associated with the player to the free-play account database 800 when the player registers with the game provider. According to another embodiment, the free-play account is instead established when complimentary game play is first awarded to the player.

At 1108, an escrow account associated with the player is established, the escrow account representing an amount to be provided to the player pending certification of a game result. For example, the game controller 400 may add a record associated with the player to the escrow account database 900 when the player registers with a game provider. According to another embodiment, the escrow account is instead established after the player has won a prize amount greater than a threshold amount.

At 1110, at least one of the player-funded account, the player-winnings account, the free-play account, and the escrow account are updated (e.g., by the game controller 400) based on game play by the player.

FIG. 12 is a flow chart of a method according to another embodiment of the present invention. At 1202, game information associated with a player is monitored. For example, the game controller 400 may monitor all information exchanged with a player device 300, including information related to the registration of the player (or the player device 300) with a game provider, games played by the player via the game system 100, payments provided from the player to a game provider, refund requests made by the player, and/or payments provided from a game provider to the player.

At 1204, an account rule stored in the account rules database 1000 is applied in accordance with the game information, and the appropriate account is updated based on the account rule at 1206. For example, the game controller 400 may determine that a player has purchased a predetermined amount of game play and increase the free-player account associated with the player.

Account Flows

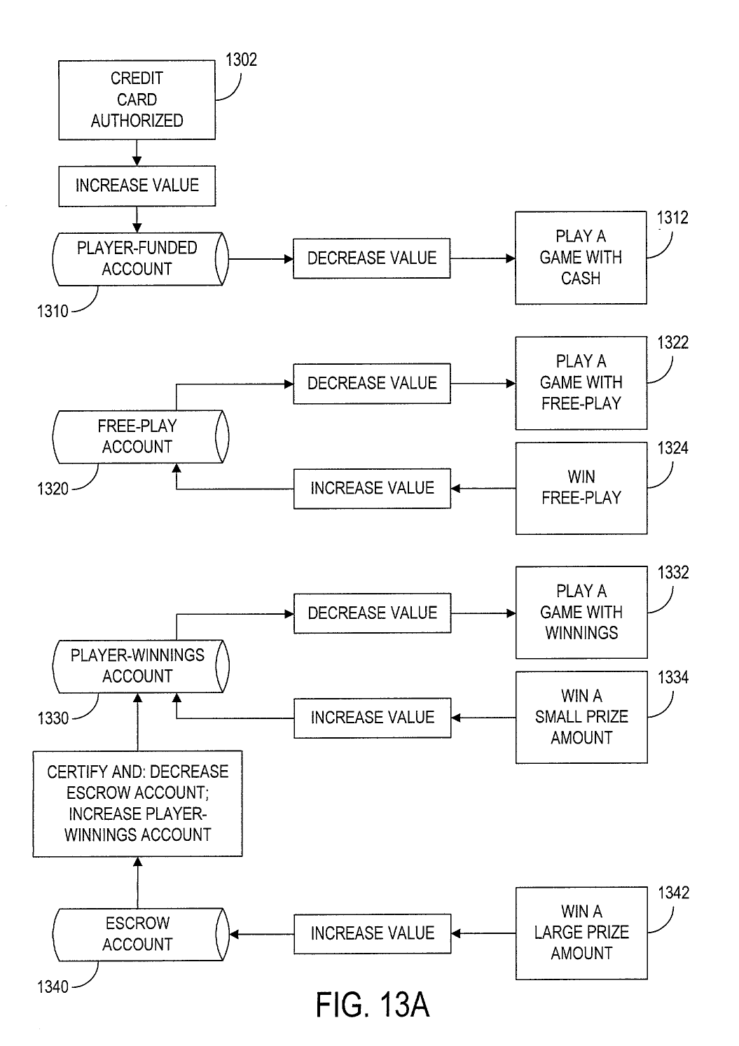

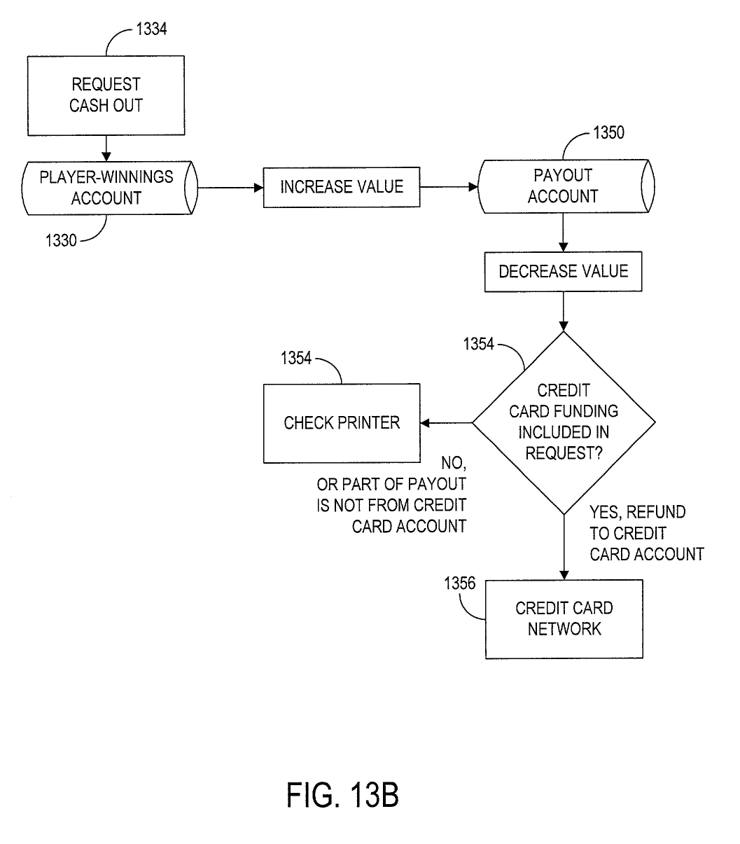

FIGS. 13A and 13B are account flow diagrams according to an embodiment of the present invention. Referring to FIG. 13A, when a player's credit card is authorized at 1302, value is added to a player-funded account 1310. For example, the game controller 400 may communicate with the payment device 110 to authorize a specific charge to the player's credit card account. The value of the player-funded account 1310 is then decreased as the player plays one or more games using “cash” at 1312. For example, the game controller 400 may decrease the amount in the player-funded account 1310 by two dollars each time the play plays a trivia game.

The value of a free-play account 1320 is decreased when the player plays one or more games using complimentary or “free” play at 1322. The value of the free-play account 1320 is increased as the player wins free plays at 1324. For example, the game controller 400 may award one dollar of free play to a player who scores at least one hundred points in a word-puzzle game.

The value of a player-winnings account 1330 is decreased when the player plays one or more games using his or her winnings at 1332. The value of the player-winnings account 1330 is increased when the player wins a small prize amount (e.g., a prize amount not greater than an escrow threshold amount) at 1334.

The value of an escrow account 1340 is increased when the player wins a large prize amount (e.g., a prize amount greater than an escrow threshold amount) at 1342. Value is transferred from the escrow account 1340 to the player-winnings account 1330 when the player's Social Security number and identification are certified (e.g., after being verified by the game controller 400). According to another embodiment, the game controller 400 also certifies that the player did not unfairly achieve a game result.

Referring now to FIG. 13B, value is transferred from the player-winnings account 1330 to a payout account 1350 when a player requests that some or all of his or her funds be “cashed out” (e.g., including amounts in the player-funded account 1310 and/or the player-winnings account 1330). The payout account 1350 may represent, for example, amounts that are being processed for payment to the player.

If the player had requested a credit card refund at 1352, value is transferred from the payout purse 1350 to a credit card network at 1356 (e.g., to the payment device 110). That is, the appropriate amount is refunded to the player's credit card account.

If the player did not request credit card funding at 1352, or if only part of the payout was originally received by the game provider from the player's credit card account, value is transferred from the payout purse 1350 to a check “printer” at 1354. A check is then printed and mailed to the player.

Note that in addition to being received from and/or provided to a player, value may be transferred between two accounts associated with a player. For example, value may be transferred from the escrow account 1340 to the player-winnings account 1330, a tax-withholding account, and/or the payout account 1350 (e.g., when a game result is certified). Similarly, value may be transferred from the player-funded account 1310 and/or the player-winnings account 1330 to the payout account 1350. Such transfers between accounts may be performed, for example, in response to a player's request (e.g., when a player requests to receive a payment) and/or when a predetermined condition is satisfied (e.g., when an amount in an account reaches a predetermined level).

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although most of the embodiments described herein are associated with a game controller 400 establishing and updating multiple accounts associated with a player, either of these functions may instead be performed by a player device 300 or a payment device 110. For example, the game controller 400 may establish and/or update a first account associated with a player, while a player device 300 establishes and/or updates a second account associated with the player. Moreover, embodiments of the present invention may or may not involve players who provide payments in exchange for game play (e.g., a sweepstakes-type prize may be awarded to a player who plays a free game).

In addition, the present invention is not limited to the particular accounts described with respect to FIGS. 6 through 9. Other types of accounts that may be used in accordance with the present invention include, for example, a payout account (e.g., representing amounts that are to be immediately paid to the player) and a game-specific account (e.g., a player may be provided with complimentary game play that can be used for a first game but not for a second game). Similarly, if the game controller 400 is associated with a number of different game providers, different accounts may be associated with different game providers.

Moreover, although embodiments of the present invention are described with respect to multiple accounts being associated with a single player, according to other embodiments multiple accounts are instead associated with multiple players. For example, a set of players (e.g., members of a family or “team” of players) may be associated with some or all of the accounts described herein.

In some of the embodiments described herein, a check is mailed to a player based on the amounts that are available in the player's player-winnings account, escrow account, and/or payout account. However, payments can also be provided to the player in other ways. For example, a game provider may give a player a payment card that the player can use to collect winning amounts via, for example, an Automated Teller Machine (ATM) device.

According to another embodiment, a game provider may establish limits associated with one or more of the accounts described herein. For example, the game provider may limit the amount in the player-funded account to $100, the amount in the player-winnings account to $10,000, and the amount in the free-play account to $20.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating game play, comprising:
establishing a player-funded account associated with a player, the player-funded account representing an amount provided by the player in exchange for game play;
establishing a player-winnings account associated with the player, the player-winnings account representing an amount to be provided to the player based on game play; and
updating at least one of the player-funded account and the player-winnings account based on game play by the player.

2. The method of claim 1, further comprising:
arranging via a payment identifier to receive payment of a funding amount from the player; and
increasing the player-funded account by the funding amount.

3. The method of claim 2, wherein the payment identifier is associated with at least one of: (i) a credit card account, (ii) a debit card account, (iii) a bank account, and (iv) a digital payment protocol.

4. The method of claim 2, further comprising:
arranging via the payment identifier to provide payment of a refund amount to the player; and
decreasing the player-funded account by the refund amount.

5. The method of claim 4, further comprising:
providing payment of an amount based on the player-winnings account to the player without using the payment identifier.

6. The method of claim 1, further comprising:
providing game play to the player; and
decreasing the player-funded account based on the provided game play.

7. The method of claim 1, further comprising:
determining a game result associated with the player; and
increasing the player-winnings account based on the game result.

8. The method of claim 7, further comprising:
determining a prize amount associated with the game result;
wherein said increasing the player-winnings account is only performed if the prize amount is not greater than a threshold amount.

9. The method of claim 1, further comprising:
providing payment of a prize amount to the player; and
decreasing the player-winnings account based on the prize amount.

10. The method of claim 1, further comprising:
providing game play to the player; and
decreasing the player-winnings account based on the provided game play.

11. The method of claim 1, further comprising:
receiving from the player a request for game play;
decreasing the player-funded account, to the extent funds are available, based on the requested game play; and
decreasing the player-winnings account, to the extent funds are not available in the player-funded account, based on the requested game play.

12. The method of claim 1, further comprising:
establishing a free-play account associated with the player, the free-play account representing complimentary game play to be provided to the player; and
updating the free-play account based on game play by the player.

13. The method of claim 12, further comprising:
monitoring game play by the player; and
increasing the free-play account based on a predetermined rule.

14. The method of claim 12, further comprising:
providing game play to the player; and
decreasing the free-play account based on the provided game play.

15. The method of claim 1, further comprising:
establishing an escrow account associated with the player, the escrow account representing an amount to be provided to the player pending certification of a game result; and
updating the escrow account based on game play by the player.

16. The method of claim 15, further comprising:
determining a game result associated with the player; and
increasing the escrow account based on the game result.

17. The method of claim 16, further comprising:
determining a prize amount associated with the game result;
wherein said increasing the escrow account is only performed if the prize amount is greater than a threshold amount.

18. The method of claim 15, further comprising:
providing payment of a prize amount to the player; and
decreasing the escrow account based on the prize amount.

19. The method of claim 18, further comprising:
evaluating a game result to decide if the game result will be certified,
wherein said providing payment is only performed if the game result is certified.

20. The method of claim 1, wherein the player plays a game of skill at a remote player device in communication with a game controller, and further comprising:
exchanging information with the remote player device via a communication network.

21. The method of claim 20, wherein the remote player device comprises at least one of: (i) a personal computer, (ii) a portable computing device, (iii) a personal digital assistant, (iv) a telephone, (v) a wireless telephone, (vi) a game terminal, (vii) an interactive television device, and (viii) a kiosk.

22. The method of claim 20, wherein the communication network comprises at least one of: (i) the Internet, (ii) a public network, (iii) a public switched telephone network, (iv) a proprietary network, (v) a cable television network, (vi) a wireless network, and (vii) a local area network.

23. A computer-implemented method of facilitating game play, comprising:
establishing a player-funded account associated with a player, the player-funded account representing an amount provided by the player in exchange for game play;
establishing a player-winnings account associated with the player, the player-winnings account representing an amount to be provided to the player based on game play;
establishing a free-play account associated with the player, the free-play account representing complimentary game play to be provided to the player;
establishing an escrow account associated with the player, the escrow account representing an amount to be provided to the player pending certification of a game result; and
updating at least one of the player-funded account, the player-winnings account, the free-play account, and the escrow account based on game play by the player.

24. A method of facilitating game play, comprising:
establishing a first account associated with a player;
establishing a second account associated with the player; and
updating at least one of the first account and the second account based on game play by the player.

25. The method of claim 24, wherein the first account comprises one, and the second account comprises another, of: (i) a player-funded account, (ii) a player-winnings account, (iii) a free-play account, (iv) an escrow account, (v) a tax withholding account, and (vi) a payout account.

26. The method of claim 24, further comprising:
arranging to separately display to the player (i) information associated with the first account and (ii) information associated with the second account.

27. The method of claim 24, further comprising:
combining (i) information associated with the first account and (ii) information associated with the second account for display to the player.

28. A game apparatus, comprising:
a processor; and
a storage device in communication with said processor and storing instructions adapted to be executed by said processor to:
establish a first account associated with a player;
establish a second account associated with the player; and
update at least one of the first account and the second account based on game play by the player.

29. The game apparatus of claim 28, wherein said storage device further stores at least one of: (i) a player database, (ii) a player-funded account database, (iii) a player-winnings account database, (iv) a free-play account database, (v) an escrow account database, and (vi) an account rules database.

30. The game apparatus of claim 28, further comprising:
a communication device coupled to said processor and adapted to communicate with at least one of: (i) a player device, (ii) a game controller, and (iii) a payment device.

31. A medium storing instructions adapted to be executed by a processor to facilitate game play, said method comprising:
establishing a first account associated with a player;
establishing a second account associated with the player; and
updating at least one of the first account and the second account based on game play by the player.
